(19) United States
(12) Patent Application Publication
(10) Pub. No.: US 2005/0278244 A1
(43) Pub. Date: Dec. 15, 2005

(54) Auction with methods and mechanisms to avoid fraud

(76) Inventor: Frank S. Yuan, San Marino, CA (US)

Correspondence Address: JONES DAY, 555 SOUTH FLOWER STREET FIFTIETH FLOOR, LOS ANGELES, CA, 90071, US

(21) Appl. No.: 10/959,671

(22) Filed: Oct. 4, 2004

Related U.S. Application Data
(63) Continuation of application No. 09/511,650, filed on Feb. 22, 2000, now abandoned.

(51) Int. Cl. G06F 17/60

(52) U.S. Cl. 705/37

(57) ABSTRACT

An auction with methods and mechanisms to avoid fraud are described. One fraud avoidance aspect involves the use of a financial institution, such as a factoring entity. The financial institution guarantees at least a partial payment of the amount owed by the winning buyer to the seller in case the winning buyer does not pay. Another fraud avoidance aspect provides the winning buyer with a period of time to inspect the goods or services purchased at the auction before having to pay for them.

### 1. FIELD OF THE INVENTION

The invention generally relates to auctions, and more specifically relates to an auction that avoids the risk of fraud to the seller and/or buyer. Fraud on the seller is avoided through the use of a financial or other institution that guarantees payment to sellers who properly deliver the goods or services that were posted during the auction. Fraud on the buyer is avoided by providing the buyer with a certain amount of time to inspect the goods or services before having to pay for them, in order to ensure that they comply with the description posted at the auction.

The invention also relates to methods and mechanisms necessary to provide the above-described auction online. The invention also relates to the interface between the auction provider and the institution used to guarantee payment to the sellers. The invention also relates to achieving the foregoing through a web site on the Internet.

### 2. BACKGROUND OF THE INVENTION

Auctions have been used to sell goods and services for some time, and with the advent of the Internet, auctions now occur online. With online auctions, buyers typically submit bids, and when the winning bid has been determined, the winning buyer typically pays for the goods at that point, e.g., with a credit card, cash or money order. Thereafter, the seller typically ships the goods or provides the services.

A problem associated with auctions, especially those occurring online, is the risk of fraud occurring on either the buyer or seller. With respect to fraud on the buyer, for example, a seller may post a certain item of merchandise in an online auction that ends up being purchased by the highest bidder. However, the merchandise actually received by the buyer may differ from the merchandise posted online, or the merchandise may be damaged or defective. Worse yet, the buyer may never actually receive the merchandise. But because the buyer has typically already paid for the goods or services prior to delivery, the buyer has thus been defrauded because it has paid money for something that is different than that posted during the auction or which is otherwise inadequate. And even if the buyer is able to get the money paid back from the seller, the buyer has still lost use of the money during this time, and has also had to expend time and possibly more money to retrieve the purchase price.

Certain auctions may involve an escrow service which receives the buyer's money when it is determined who submitted the winning bid. But with an escrow service, the buyer has still parted with the money before receiving the goods or services which may be different than those posted at the auction. Accordingly, even though the seller may not instantaneously receive payment because the money is with an escrow service, the buyer has still parted with-the purchase price and still runs the risk of being defrauded. At a minimum, the buyer runs the risk of losing use of the money until any bad situation is rectified and the money returned from escrow.

With respect to fraud on the seller, if the auction does not involve the immediate payment by the buyer, the buyer may end up receiving the proper merchandise posted during the auction but then fail to pay for it. In this case, the seller has been defrauded because it has shipped the proper item but receives no payment. And in this situation, the seller typically waits for payment for some period of time before it becomes apparent that payment is not forthcoming. Had the seller known that payment was not forthcoming, it might have approached the second-place bidder as an alternate buyer. But because the seller is still expecting payment from the winning bidder, by the time the fraud becomes apparent the second-place bidder will most likely have moved on with alternate arrangements. So besides the problem of having shipped the merchandise to the fraudulent buyer, the seller also loses out on a proper sale.

Problems associated with fraud may be exacerbated in online auctions because such auctions are not face-to-face. Instead, the parties involved are remote from each other so there is no real opportunity for the buyer to inspect the items being auctioned, or for the buyer and seller to meet face-to-face in order to create some type of business relationship prior to money changing hands. To this end, because the sellers and buyers interfacing through online auctions do not know each other, they may not know each others' reputations and may thus be selling or buying items where a high chance of fraud exists.

The risk of fraud may also be increased in the wholesale environment as opposed to retail transactions. In typical retail transactions, the buyer may simply pay cash for the items purchased. In this situation, the seller receives the money at the time of the transaction so there is little or no chance that the seller will be defrauded. Alternatively, the buyer may use a credit card or other bank card for the purchase. But here again, the seller is protected against fraud because the bank that issued the card will stand behind the buyer and thus guarantee payment. Conversely, for retail transactions that occur face-to-face, the buyer can inspect the items being purchased to ensure that they are of proper quality before money changes hands. And if they are not, the seller can be confronted then and there.

But in the wholesale environment, which may involve transactions between a supplier and a manufacturer, or between a manufacturer and a retailer, the seller typically receives no such protection. This is because most wholesale transactions do not involve cash or credit cards, but instead involve terms which provide for payment within some amount of time. Accordingly, the seller does not receive money at the time of the transaction and does not benefit from any bank standing behind the user of a credit card. Conversely, many wholesale transactions do not occur face-to-face so the buyer may not have the opportunity to inspect the items before money changes hands. It should be noted that these problems may also apply to retail transactions, but in any event, may be exacerbated in the wholesale environment.

Besides the fraud which may arise in connection with an auction, another problem associated with an auction transaction gone awry is wasted time. That is, after the auction occurs and the highest bidder wins, the seller and buyer have a reasonable expectation that the transaction is consummated and the only remaining tasks are for the items to be shipped and, if it has not already occurred, money to change hands. However, where the items are provided at some time later and turn out to be defective or otherwise inadequate, time has been lost. This may create significant problems for buyers who needed the goods or services in order to consummate business with third parties. Conversely, where the proper items are provided but payment is not forthcoming, time has again been lost, in this case for the seller. Unfortunately, significant time may pass before the seller and/or buyer realize(s) this. And for either a buyer or seller, such lost time may jeopardize their business plans when it comes to light that the proper items or monies have not been received.

Financial institutions have been used in connection with the sale of goods and services for some time. For example, if the seller meets certain qualifications, the seller may enter into an agreement with a financial institution whereby the financial institution will guarantee the buyer's credit worthiness or payment to the seller for goods sold. To this, end, the financial institution may advance some or all of the payment to the seller and then go about collecting the account receivable from the buyer. As such, the financial institution may assume the risk of nonpayment by the buyer. In return, the financial institution typically receives a commission or some other fee from the seller.

An example of this type of arrangement involves financial institutions known as factors whereby the factor and seller enter into what is known as a factoring agreement. This agreement typically specifies the type of payment guarantee that will be provided to the seller, the type of risk that will be assumed by the factor, the commission or other fee to be received by the factor and other pertinent terms.

However, financial institutions such as factoring entities have not been involved in an auction setting. A reason for this may derive from the one-on-one relationship between the financial institution and seller that is typically associated with factoring or other types of payment guarantees provided by financial institutions. That is, financial institutions typically require some amount of time to process an application by the seller, run financial checks on the seller and become generally familiar with the seller before it will make any type of payment guarantee.

However, the time required for this process runs contrary to an auction process where a seller may want to quickly post goods or services for sale without having to go through any type of time-consuming financial evaluation. Indeed, the auction setting provides little or no time for the classical approach to factoring or other types of payment guarantees whereby one-on-one relationships are established before any risk is assumed by the financial institution. Accordingly, it can be seen why financial institutions would not want to rush into providing payment guarantees for sellers at an auction, because if it did, the financial institution could very well be assuming unknown and unnecessary risks that it would not have assumed the classical one-on-one approach been followed.

Consequently, auctions that currently exist have not benefited from the security and fraud-avoidance benefits that may be provided by a financial institution such as a factor. Furthermore, many auctions do not provide any type of time period for buyers to inspect or otherwise ensure that the items purchased conform to what was posted during the auction or that the items are free from defects.

In view of the foregoing, there is a need for an auction system and method that avoids the risk of fraud and the waste of time described above. To this end, there is a need for an auction involving a financial institution which guarantees payment on certain conditions so that sellers can offer their goods to buyers with the benefit of the protection provided by guaranteed payment. There is also a need for an auction whereby the buyer has an amount of time to inspect the goods or services before parting with his or her money. And in today's rapidly expanding world of e-commerce, there is a need for the foregoing to occur online.

### 3. SUMMARY OF THE INVENTION

The current invention addresses the need to avoid fraud by providing an auction that involves a financial institution, such as a factoring entity, to provide some form of guaranteed payment to sellers who deliver appropriate goods or services. The current invention also addresses the need to avoid fraud by providing the buyer with an amount of time to inspect the goods or services before actually having to pay for them. The current invention also serves to avoid fraud by combining these concepts, and by providing for the foregoing to occur online.

The current invention may be embodied by a web site on the Internet that includes an auction center. Sellers who have met the criteria of the entity managing the auction and the financial institution may sell items in the auction center and receive guaranteed payment where appropriate. It is preferred that sellers are able to apply online to receive the benefit of a factoring or other similar agreement. Buyers who meet criteria to participate in the auction center are provided with a time period, e.g., 30 days, in which to evaluate the goods or services that they receive before actually having to pay for them. The buyers' credit may also be prequalified online so that the risk of nonpayment is decreased. Thus by involving a financial institution and by providing a pre-payment evaluation period, the risk of fraud to the seller and buyer is avoided.

### 4. DESCRIPTION OF THE FIGURES

FIG. 1 is a flowchart showing an overall schematic of the entities involved with an auction center of the current invention and their relationships.

FIG. 2 is a flowchart describing an auction from the viewpoint of a financial institution that will provide some form of payment guarantee to sellers, and who may pre-qualify buyers before they bid at the auction.

FIG. 3 is a flowchart describing an auction from a seller's viewpoint.

FIG. 4 is a flowchart describing an auction from a buyer's viewpoint.

### 5. DETAILED DESCRIPTION OF THE PREFERRED EMBODIMENTS

In a preferred embodiment, the auction of the current invention may be embodied as a web site on the Internet. Various types of business transactions may occur via the auction. For example, the auction may be used as a business-to-business vertical marketplace or community where manufacturers, wholesalers and jobbers can liquidate bulk product quantities including odd lots and close-outs. Retailers of varying sizes may also participate in the auction to efficiently source product at better prices. The subject matter of the goods and/or services to be auctioned may also vary. In one example, the products to be auctioned may involve clothing and clothing accessories. However, a multitude of other products and/or services may be auctioned using the method of the current invention.

In the current invention, a particular web site may host multiple auctions on different web pages according to the subject matter of the goods and/or services being auctioned. Alternatively, different web sites may exist, each having its own auction according to a particular subject matter of goods or services being auctioned. As yet another alternative, one auction site may be used for goods and/or services that are unrelated to each other.

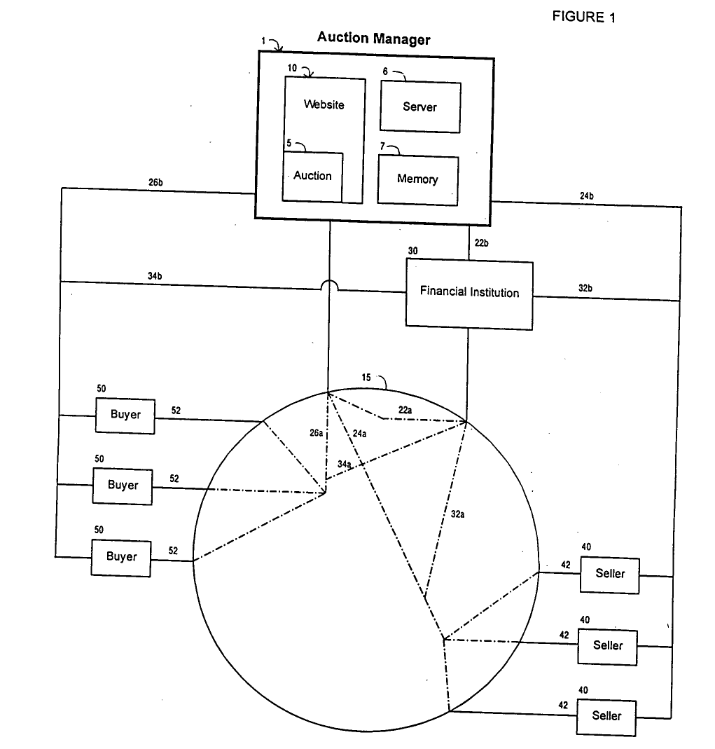

Referring to FIG. 1, the entities involved in the auction and the relationships between these entities are now described. As shown, auction manager 1 may provide an auction 5. For purposes of the following discussion, auction manager 1 generally refers to the entity that coordinates the auction. To this end, and in a preferred embodiment, auction 5 may be contained on a web site 10 that may be administered by auction manager 1. In order to provide the auction, auction manager 1 may also include a server 6 on which web site 10 may reside, as well as any memory 7 that may be accessed for the auction or other purposes.

In FIG. 1, auction 5 is shown as a part of web site 10 because auction manager's web site 10 may provide other functions beside auction 5. To this end, there may be several auctions 5 on web site 10, or alternatively, auction manager 1 may provide multiple auctions on separate web sites. Accordingly, FIG. 1 is not intended to limit the current invention to one auction occurring on one web site.

The other entities involved with auction 5 may be factor 30, sellers 40 and buyers 50. It is preferred that these entities be electronically linked through the Internet 15 or some other type of network. Such electronic communication preferably reduces the transactional costs associated with holding the auction and also preferably increases efficiency. As shown in FIG. 1, auction manager may be linked to financial institution 30 by electronic link 22a, to sellers 40 by electronic link 24a and to buyers 50 by electronic link 26a. Furthermore, financial institution 30 may be linked to sellers 40 via electronic link 32a and to buyers 50 via electronic link 34a.

The electronic links that extend from financial institution 30 to sellers 40 and to buyers 50 may allow online applications to be filled out and evaluated. For example, sellers 40 may apply online for the services of the financial institution 30, e.g., payment guarantees as discussed in more detail later. As another example, buyers 50 may fill out and transmit online credit applications to financial institution 30.

In any event, the current invention is not limited to auctions occurring solely by electronic means, as the fraud avoidance aspects disclosed herein may be used in more traditional, physical auctions. Furthermore, even where online connectivity between the parties is used, the current invention may include the use of non-Internet, more traditional modes of communication between the entities such as phone conversations and other human or documentary communication. To this end, auction manager 1 may be linked to financial institution 30 through non-Internet communication line 22b, to sellers 40 through line 24b and to buyers 50 through line 26b. In this manner, the entities may communicate through whatever means necessary to assure the integrity and efficiency of auction 5.

For purposes of this discussion, the relationships or agreements between the parties are explained by using the foregoing reference numerals without the “a” or “b”. As an example, the relationship or an agreement between auction manager 1 and financial institution 30 is discussed by general use of the reference numeral 22. As another example, the agreement between financial institution 30 and seller 40 uses reference numeral 32. This may include contractual obligations between the pertinent parties.

Where financial institution 30 is a factoring entity, relationship 22 between auction manager 1 and factor 30 may obligate factor 30 to pay certain commissions and/or fees to auction manager 1 for each factoring agreement that factor 30 obtains by virtue of its association with auction 1. Similar arrangements can also exist between auction manager 1 and other types of financial institutions 30 such as banks or credit assurance companies. That is, bank 30 or credit assurance company 30 may pay a fee or commission to auction manager 1 for each agreement that is obtained with a seller 40 by virtue of the bank's or credit assurance company's association with auction 5.

Relationship 22 between auction manager 1 and financial institution 30 represents a novel aspect of the current invention pertaining to the use of a financial institution in an auction setting. Relationship 22 reflects a significant difference from the classical one-on-one approach that exists between a financial institution and a seller for which it will guarantee payment. That is, with relationship 22, financial institution 30 need not establish one-on-one relationships with each seller 40, which may in any event not be possible if sellers 40 want to quickly participate in auction 5 instead of going through a time-consuming evaluation process. Instead, financial institution 30 has a one-on-one relationship 22 with auction manager 1, and it may be auction manager 1 that attracts and develops relationships 24 with sellers 40. This is discussed in more detail below in connection with single transaction factoring agreements.

Referring now to the other relationships or agreements between the other parties in FIG. 1, agreement 32 may represent the agreement in place, e.g., factoring agreement, between financial institution 30 and sellers 40. As another example, relationship 24 between auction manager 1 and seller 40 may generally provide that a seller 40 agrees to be bound by certain auction rules in order for seller 40 to participate in auction 5. As another example, relationship 26 between auction manager 1 and buyer 50 may also set forth auction rules that buyer 50 must follow in order to participate in auction 1.

As shown in FIG. 1, sellers 40 may have a relationship 42 with auction 5. This generally represents the seller's posting of goods and/or services to be auctioned and the actual sale of such goods and/or services. Buyers 50 may also have relationship 52 with auction 5 which represents the buyer's bidding on and purchasing of goods and/or services via auction 5.

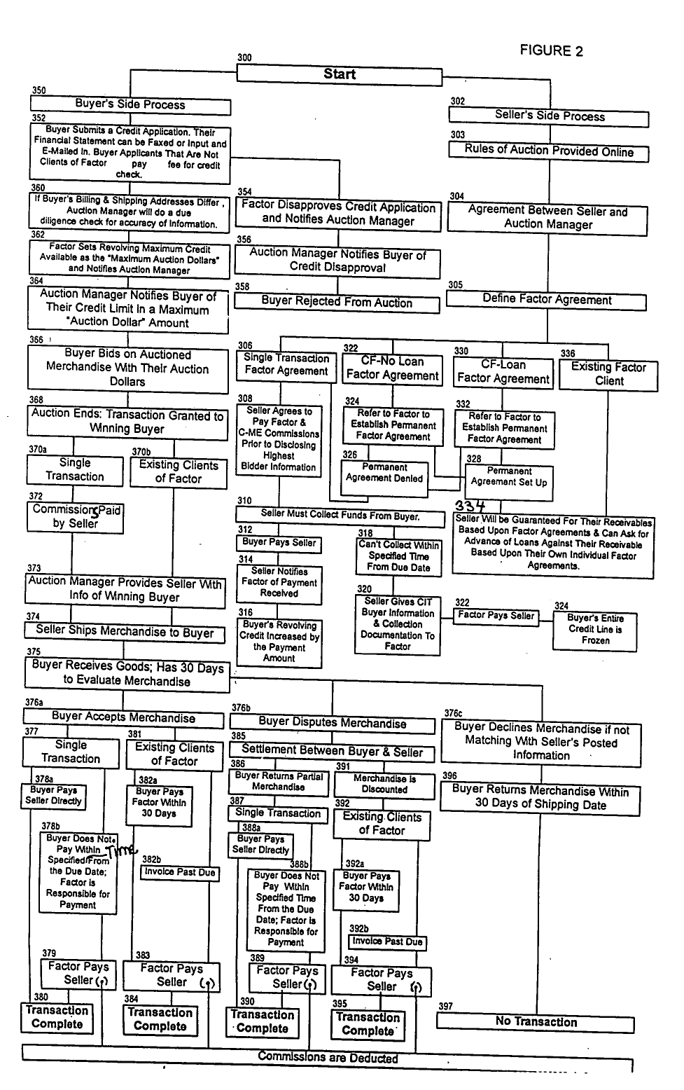

Now that the entities involved with auction 5 have been described, the manner in which these entities interact with each other and with auction 5 is more fully described with reference to FIGS. 2, 3 and 4. FIGS. 2, 3 and 4 show the auction method of the current invention from the viewpoints of the factor or other financial institution 30, seller 40 and buyer 50, respectively.

Referring now to FIG. 2, the method from the financial institution's viewpoint begins at step 300. For purposes of the following discussion, the financial institution is generally referred to as being a factoring entity. However, the current invention includes the use of other types of financial institutions that may provide services for use in avoiding fraud in the auction context. Examples include, but are not limited to, banks and credit assurance companies. Accordingly, throughout this application, including the discussion both above and below, the use of the phrase “factor”, “factoring” or “factoring agreement” is not intended to limit the scope of the invention to this type of particular financial institution.

Upon the method starting with step 300, it is preferred that factor 30 has a relationship 22 (FIG. 1) with auction manager 1 regarding factoring agreements to be entered into for purposes of auction 5. As mentioned above, relationship 22 may involve some sort of contractual obligation whereby factor 30 pays a certain commission or fee to auction manager 1 for each such factoring agreement. That factor 30 would pay such fees or commissions is reasonable because the factor's participation in auction 5 will expose it to numerous prospective sellers, which in turn will lead to numerous factoring agreements which may each involve fees or commissions being paid by sellers 40 to factor 30.

As shown in FIG. 2, factor 30 may be involved with a seller's side process 302 and a buyer's side process 350. The seller's side process 302 is discussed first. Generally, it is preferred that sellers 40 may be able to learn about auction 5 and apply to participate therein online over the Internet 15. To this end, it is preferred that web site 10 provide the ground rules of auction 5 online, as shown in step 303, so that seller 40 may determine whether it wants to participate in the first place.

One possible ground rule of auction 5 may be a minimum posting requirement, i.e., a minimum value of the goods or services to be posted for auction, for seller 40 to be able to participate in auction 5. Due to transactional costs incurred by auction manager 1 and the risks assumed by factor 30 when providing some form of payment guarantee, it may not make economic sense to provide auction access to sellers that want to post goods or services having too small a value. Accordingly, auction 5 may have a minimum posting requirement, e.g., $5,000.

Another possible ground rule is that seller 40 will pay a certain fee or commission to auction manager 1 for each sale consummated via auction 5. Such a fee or commission would be reasonable since participation in auction 5 would expose seller 40 to numerous prospective buyers 50.

Assuming seller 40 wishes to proceed and participate in auction 5, seller's side process 302 may continue with steps 304, 305 whereby seller 40 fills out online applications to be evaluated by auction manager 1 and factor 30, respectively. For example, rules 303 may be set forth on a web page for seller 40 to view, and at the end thereof, seller 40 may be requested to provide pertinent contact and financial information. After doing so, seller 40 may then be prompted to click an “accept” icon or “reject” icon appearing at the end of the application. The seller's acceptance may serve to submit its application (step 304) to participate in auction 5. Upon its receipt of the seller's application, auction manager 1 may be provided with several days or some other amount of time in order to accept or reject the prospective seller's application. If accepted by auction manager 1, agreement 24 between auction manager 1 and seller 40 may be established.

In similar fashion, seller 40 may also submit an online application as in step 305 to factor 30 that will result in agreement 32, e.g., a factoring agreement. Different types of possible factoring agreements 32 may appear on the prospective seller's computer screen. And if the prospective seller finds a factoring agreement acceptable, it may then submit an application to factor 30. This may occur by the prospective seller providing information about itself in an online form and clicking an icon that indicates that the prospective seller agrees to bound by the terms of the factoring agreement in order to participate in auction 5. Upon its receipt of the application, and depending on the type of factoring agreement at issue, factor 30 may be provided with some amount of time to consider the application.

It should be noted that the prospective seller's applications with auction manager 1 and factor 30 need not necessarily be submitted online through the Internet 15. Instead, hardcopy documents may be used. Furthermore, it may not be necessary that the seller submit its application to auction manager 1 prior to submitting its application with factor 30. Either of steps 304, 305 may occur first.

Furthermore, it may also be that seller 40 does not need or desire factoring services. In this situation, he may not apply with factor 30, but instead may simply apply to participate in the auction 5 without the benefit of some form of payment guarantee. However, it is still preferred that a buyer 50 of that seller's goods or services still be provided with a period of time in which to inspect the delivered goods or services so that fraud on the buyer is avoided.

As shown after step 305 in FIG. 2, various types of factoring agreements may be entered into between factor 30 and seller 40. The terms and conditions of the factoring agreement 32 may vary depending on whether factor 30 and seller 40 have a prior relationship, the amount of risk to be assumed by factor 30 and the extent of services to be provided by factor 30. Several types of factoring agreements 32, and how they function in related to auction 5, are now discussed in more detail.

As shown in step 306, a first type of agreement 32 between factor 30 and seller 40 may cover a single transaction, e.g., one sale by seller 40 at auction 5. This agreement may also require that seller 40 attempt to collect payment for some agreed upon time period before factor 30 becomes liable for the account receivable.

Under this arrangement, and as shown in step 308, seller 40 may be obligated to pay the appropriate commissions and/or fees to auction manager 1 and factor 30 up front, i.e., before information on the winning bidder is disclosed to seller 40. It is preferred that fees or commissions be paid prior to disclosure of information on the winning bid to prevent seller 40 from circumventing the auction process after having received the benefit of obtaining a buyer through the auction.

When considering this single transaction agreement 32, factor 30 may evaluate the size of the account receivable, the seller's 40 ability to collect payment from the buyer 50 as well as the credit worthiness of the winning bidder 50. But with respect to the buyer's credit, it is preferred that the buyer 50 would have had its credit approved prior to participating in auction 5. Accordingly, the risk of providing some form of payment guarantee is not so large as it might be if buyer's credit had not been pre-checked. In any event, these factors may in turn determine the size of the payment guarantee that factor 30 is willing to extend to seller 40.

After the information regarding the winning bidder is disclosed to seller 40, seller 40 may then ship the goods or provide the services to buyer 50. The factoring agreement 32 may have a term which provides that the payment guarantee is contingent upon the proper goods or services being delivered, i.e., those posted at the auction. Along with the goods or services, an invoice or other appropriate documentation may be sent to buyer 50 electronically and/or in hard copy document form. That an invoice is generated to buyer 50 may also help avoid fraud because should the incorrect buyer receive an invoice for items it did not bid on, the incorrect buyer can notify auction manager 1 of the error prior to delivery. A proof of delivery may also be sent to auction manager 1 and factor 30 to establish that the proper goods or services were delivered.

Per the factoring agreement 32 of step 306, seller 40 may then be provided some amount of time to collect payment from buyer 50 as shown in step 310. If seller 40 is successful in collecting payment as shown in step 312, seller 40 may notify factor 30 that the payment has been received as in step 314. As shown in step 316, the seller's successful collection may serve to develop a good track record and may result in an increase in the payment guarantee that factor 30 is willing to provide in future transactions. Factor 30 may also agree to increase the credit limit of buyer 50 based on their payment.

The alternative scenario is where seller 40 is unsuccessful in collecting payment the some period of time provided for in agreement 32 as shown in step 318. Here, seller 40 may provide factor 30 with information pertinent to the collection attempts and may request payment from factor 30 as shown in step 320. At this point, factor 30 follows through on the guaranteed payment as in step 322 thereby serving to avoid fraud on the seller 40 who delivered the goods or services as originally posted at the auction but was not paid therefor.

Factor 30 then also assumes the obligation to collect payment. Based on the buyer's 50 poor track record generated from this scenario, however, the buyer's credit line for the auction may be frozen as shown in step 324. In this manner, buyer 50 may not be able to participate in further auctions 5 until payment is made to factor 30. Buyer 50 may also be precluded from further auctions 5 until additional credit rehabilitation requirements are met. This aspect again shows how the current invention serves to avoid fraud. That is, the buyer who has failed to pay, is prevented from perpetrating further fraud in subsequent auctions 5 until its credit is re-established.

This factoring arrangement 306 which covers one transaction may generally involve less risk to factor 30 than other types of standard factoring agreements because factor 30 receives an up-front fee and does not assume any risk until after seller 40 first attempts to collect payment. However, this arrangement may still be desired by seller 40 because it may involve a smaller fee due to the smaller risk assumed by factor 30. Such an arrangement may also be desirable where factor 30 and seller 40 have no prior relationship, and where the seller's other existing accounts receivables are already processed with another factor or other financial institution.

Though factor 30 may initially receive an application from seller 40 and may perform some amount of evaluation, it is intended that the single transaction agreement be provided quickly. To this end, it is preferred that the majority or vast majority of prospective sellers 40 that seek to participate in auction 5 with auction manager 1 will be able to readily obtain a single transaction agreement. This serves to allow seller 40 to participate in auction 5 as quickly as possible.

As such, the single transaction factoring agreement represents a deviation from the classical one-on-one approach that exists with typical factoring or other payment guarantees made by financial institutions. That is, prospective sellers generally interface with auction manager 1 and have a relationship 24 therewith in order to participate in auction 5. And by virtue of this relationship 24, prospective sellers may readily obtain a single transaction factoring agreement without undergoing an extensive evaluation process and establishing an in-depth one-on-one relationship with factor 30. Indeed, at least on the front end, the relationship with factor 30 is more or less with auction manager 1 rather than with a multitude of sellers 40. To this end, the relationship between factor 30 and seller 40 does not really come significantly into play unless buyer 50 reneges on the purchase price. Also, it is contemplated that auction manager 1 may itself provide single transaction agreements.

As mentioned above, the single transaction factoring agreement 306 may be especially suited for sellers having no prior track record with factor 30. However, it is preferred that seller 40 develop a good track record with factor 30 after consummating several sales via auction 5 wherein the single transaction agreement was used. For example, seller 40 may develop a good track record where it consistently delivered the appropriate goods or services as they were posted during the auction and where it successfully collected payments from buyers 50 thereby avoiding the need for factor 30 to expend much effort.

Where a good track is established, seller 40 may have the option to obtain a factoring agreement that provides more service by factor 30. An example is a factoring agreement that covers multiple transactions and wherein factor 30 advances all or part of the account receivable without seller 40 having to first attempt to collect it. This type of agreement is referenced in FIG. 2 as step 322. Another example is a factoring agreement that has these attributes but that also allows seller 40 to borrow money against its accounts receivables. This type of agreement is shown in FIG. 2 as step 330.

For a seller to obtain one of these fuller-service factoring agreements, factor 30 may by that time have had ample time to assess the seller's performance and thereby establish more of the one-on-one relationship that is typically associated with classical factoring. However, it is contemplated that the readily-available single transaction factoring agreement, along with its deviation from the classical one-on-one relationship between seller and factor, will place sellers in a position to obtain a fuller-service agreement.

From a business standpoint, the current invention provides that sellers 40 may start out with single-transaction factoring agreements 306 which provides sellers that may not otherwise be eligible for factoring agreements the ability to transact business in auction-5. As mentioned above, it is intended that prospective sellers will be able to readily obtain a single transaction agreement. But based on a good track record, sellers 40 may then essentially graduate to more service-laden factoring agreements 322, 330 which will provide more service and flexibility in the way sellers 40 may do business. Accordingly, the utility of the method of the current invention is shown. Another aspect of the utility of this business method is that each of these different types of factoring agreements generate fees and/or commissions for auction manager 1 and factor 30 which in turn allow auction 5 to be held in the first place.

The factoring agreement of step 322, which is generally referred to as a no-loan factoring agreement is now more fully discussed. As mentioned above, this type of factoring agreement is different than the single transaction agreement discussed in step 306 for several reasons. First, this type of factoring agreement may cover a series of sales transactions that seller 40 may consummate via auction 5 instead of just one. Accordingly, in this alternative, a new factoring agreement for each sale on auction 5 is unnecessary. Second, this type of factoring agreement may not require that seller 40 first attempt to collect payment from buyer 50 before requesting payment form factor 30. Instead, after the winning bidder is designated and seller 40 has delivered the goods or services, seller 40 may request payment from factor 30 at that time.

In any event, as shown in step 324, seller 40 may be referred to factor 30 to determine whether seller 40 qualifies for the no-loan factoring agreement 322. If seller 40 does not qualify, as shown in step 326, it may be referred back to the single transaction factoring agreement 306. In this scenario, seller 40 may consummate another transaction via auction 5 in hopes of establishing or fostering its track record such that at some point, it may obtain a no-loan factoring agreement 322 for subsequent transactions.

If seller 40 does qualify for the no-loan factoring agreement, the appropriate no-loan factoring agreement 322 may be entered into, and seller 40 may then transact business via auction 5 with the enhanced benefits of this type of factoring agreement 322. That is, seller 40 may sell goods or services and receive partial or full payment from factor 30 without first having to attempt collection itself. This may increase the seller's cash flow and provide other commercial benefits.

Similar to the other relationships and agreements-between the parties discussed above, it is preferred that the seller/factor relationship 32 involving either of the factoring agreements 306, 322 may be consummated online via communication 32a (FIG. 1). However, non-Internet communication 32b may also be used.

The type of factoring agreement that provides the foregoing benefits but that also allows seller 40 to borrow against its accounts receivable is now discussed with reference to step 330. This type of factoring agreement is generally referred to as a loan factoring agreement. Here, seller 50 may again be referred to factor 30 to determine whether seller 40 qualifies for this type of factoring agreement as shown in step 332. If not, seller 40 might be given the option of a no-loan factoring agreement 322. Alternatively, seller 40 may be referred to the single transaction factoring agreement as shown in steps 326, 306.

If seller 40 does qualify for the loan factoring agreement, the appropriate loan factoring agreement 330 may be entered established as shown in step 328, and seller 40 may then transact-business via auction 5 with the enhanced benefits of this type of factoring agreement 330. That is, seller 40 may sell goods or services and receive partial or full payment from factor 30 without first having to attempt collection itself, and may also borrow against its accounts receivable as shown in step 334. With this type of factoring agreement, interest fees from seller 40 to factor 30 on such loans may be generated. In any event, the enhanced benefits provided by this type of factoring agreement may increase the seller's cash flow and provide other commercial benefits.

In addition to the scenarios involving the single transaction factoring agreement 306, the no-loan factoring agreement 322 and the loan factoring agreement 330, another scenario accommodated by the current invention is where seller 40 is an existing client of factor 30 as shown in step 336. Here, seller 40 presumably has some type of good track record with factor 30 and may thus participate in auction 5 with the benefit of a no-loan or loan factoring agreement as shown in step 334. However, it is intended that this type of seller 40 still register for auction 5 via the application process with auction manager 1. As with the establishment of other relationships discussed above, it is preferred that sellers 40 that are existing clients of factor 30 register for auction 5 online. However, non-Internet communications may still be used.

For all the types of factoring agreements discussed above, it is preferred that factor 30 quickly perform whatever research is necessary before it enters into an agreement with a prospective seller. Where the prospective seller is an existing client, no research may actually be necessary. Where the single transaction agreement 306 is to be used, the research necessary may be minimal since less up-front risk is being assumed by factor 30. Where fuller service factoring agreements, e.g., no-loan or loan agreements 322, 330, are being considered, factor 30 may need additional time to perform UCC checks and the like. In any event, it is contemplated that online research may reduce the amount of time necessary.

Reference is now made to the buyer's side process 350 of FIG. 2. The first step in this process may be an application step 352 where buyer 50 may submit a credit application in order to participate in auction 5. The application may include whatever financial information is necessary. The application is preferably submitted online 26a (FIG. 1) through auction manager 1 which may the pass the application on to factor 30. For example, the credit application may simply appear as a form with fields on the prospective buyer's computer screen that may be readily filled out. However, non-Internet communication 26b (FIG. 1) may also be used in the application process, e.g., faxed financial statements, telephone calls to verify information, etc. Alternatively, the credit application may be directly transmitted to factor 30, but here, it is still preferred that auction manager 1 be kept apprised of prospective buyers applying to participate.

In the course of its business, factoring entities generally maintain databases of credit information on many retailers and other entities of the type that may want to participate in auction 5. Accordingly, it is contemplated that factor 30 may already have credit information on a particular prospective buyer. If this is the case, the application step 352 may occur rapidly with a minimum of transaction effort and cost.

If factor 30 does not already have information on the prospective buyer, factor 30 may receive an application fee for performing the credit check. While the credit evaluation may take some amount of time if the prospective buyer is not already in factor's 30 database, it is preferred that the credit check be completed as quickly as practical so that the buyer may participate in auction 5 as soon as possible. In any event, factor 30 may consider the credit application to determine whether the prospective buyer will be approved for participation in auction 5 or rejected therefrom.

If factor 30 rejects the prospective buyer's application, it may notify auction manager 1 as shown in step 354. Auction manager 1 may then notify the rejected prospective buyer as in step 356. The prospective buyer is thus rejected as shown in step 358. It is preferred that auction manager 1 be notified of all rejections so that it may maintain databases in memory 7 (FIG. 1) of prospective buyers should a particular prospective buyer re-apply to participate in auction 5 at some time in the future. To this end, a prospective buyer might be reconsidered in the future should the buyer's credit or other information change such that it meets the requisite credit standards to participate in auction 5.

After the prospective buyer's credit is checked by factor 30, or concurrently with the factor's evaluation of the credit application, auction manager 1 may perform a due diligence step 360 to address the following issue. In today's economy, many retailers and other entities of the type that may participate in auction 5 have billing and shipping addresses that differ. Because of this, it is possible that confusion, mistake or fraud may arise in connection with the delivery and payment of goods or services purchased on the auction 5. For example, if goods purchased at auction 5 are delivered to an address that is different than the address from which payment will be made, the payment address may not actually have first-hand knowledge whether the goods were actually delivered. This could result in goods being properly delivered to a shipping address but the buyer's authorized payment personnel located at another address refusing to pay.

To address this situation, where the prospective buyer's shipping and billing addresses differ, auction manager 1 may perform due diligence 360 to verify the accuracy of both addresses. This due diligence step 360 may also include verification that there is some form of communication channel between the buyer's shipping and billing addresses so that payment for properly delivered goods or services cannot be improperly refused. It is preferred that any such due diligence occur before buyer 50 is allowed to bid on any goods or services posted for auction.

If the prospective buyer is approved, factor 30 preferably sets up a credit limit for buyer 50 and notifies auction manager 1 as shown in step 362. It is preferred that the credit limit be expressed in a maximum amount of “auction dollars” that are available to buyer 50. Auction dollars may simply reflect the amount of buying power that buyer 50 has for an auction 5, regardless of whatever monies buyer 50 may have.

It is preferred that credit limit information be sent to auction manager 1 so that auctions may be run in an orderly manner. For example, when conducting an auction, auction manager 1 may refuse bids from buyers 50 who have exceeded their credit limit. This reflects another aspect of fraud avoidance of the current invention in that winning bids that are excessive and thus have little or no chance of actually being paid, are avoided. At this point, auction manager 1 may then notify buyer 50 that it has been approved and may also advise buyer 50 of the buyer's credit limit as shown in step 364.

Larger buyers 50 with more assets and credit worthiness may benefit from larger credit limits. However, a smaller buyer's credit limit might also increase over time as the buyer displays creditworthiness through timely payment for goods or a series of goods purchased at auction 5. The current invention also contemplates that buyer 50 might also be able to petition factor 30 and/or auction manager 1 for an occasional credit variance to allow buyer 50 to purchase goods or services that exceed the buyer's existing credit limit.

When buyer 50 is notified of its credit limit, buyer 50 may then participate in an auction 5 as shown step 366. When auction 5 occurs, it is preferred that the posted goods are graphically shown so that buyers 50 bidding thereon have a visual description thereof. Other characteristics of the goods or services may be textually displayed. And if buyer 50 has sound card capability in its computer or other terminal, an audio description may also be provided.

It is preferred that buyers 50 may submit their bids online as the auction 5 progresses. The length of time that the auction may be open for bids may vary. For example, if too few bids have been made, auction manager 1 may keep auction 5 open for a longer time. In any event, a winning buyer 50 will eventually be designated. The winning buyer may generally be the buyer 50 who was the highest bidder. However, the current invention may involve other types of auctions where the winning buyer may not have necessarily submitted the highest bid.

In any event, after the winning buyer has been designated, the type of factoring agreement in place with seller 40 is then considered. As shown in step 370a, a single transaction factoring agreement is involved, and as shown in step 370b, a full service factoring agreement is involved, e.g., no-loan factoring agreement or loan factoring agreement which is typically synonymous with existing clients of factor 30. That is, before a seller 40 may obtain a no-loan or loan factoring agreement covering multiple transactions, it will have developed a good enough track record to be considered a client of the factor as represented by step 328.

If the single transaction factoring agreement 306, 370a is involved, it is preferred that the fees and/or commissions due from seller 40 to auction manager 1 and factor 30 be paid prior to step 372 where information on the designated winning buyer 50 is disclosed. This is preferred to avoid the situation where the winning buyer 50 and seller 40 consummate the transaction by circumventing auction 5 after having received the benefits thereof. Such prepayment may be unnecessary where the seller 50 is an existing client of factor 30 because their existing relationship will generally preclude this surreptitious activity.

In any event, auction manager 1 may then provide seller 40 with the shipping, billing and other necessary information of the highest bidding buyer 50 as shown in step 373. Seller 40 may then ship the auctioned goods or provide the auctioned services to buyer 50 as shown in step 374, and buyer 50 may then receive the auctioned items as shown in step 375.

As also shown in step 375, it is preferred that buyer 50 has some amount of time to evaluate the merchandise before paying for it. This reflects the fraud avoidance aspect of the current invention because this evaluation period allows buyer 50 the time to ensure that the merchandise comports with the merchandise posted during the auction before money actually changes hands. In a preferred embodiment, buyer 50 has thirty days to evaluate the merchandise.

If the merchandise comports with that posted during auction 5, buyer 50 may accept the merchandise as shown in step 376a. Alternatively, the buyer may dispute the merchandise for some reason as in step 376b. As another alternative, buyer 50 may decline the merchandise as in step 376c because it does not comport with the merchandise posted at auction 5.

Factor 30 may become involved where buyer 50 accepts or disputes the merchandise. And as discussed above, the factor's involvement represents a novel aspect of the current invention in that seller 50 benefits from a payment guarantee once the proper goods or services have been delivered. In any event, where buyer 50 accepts the goods or services, the factor's involvement may depend on the type of factoring agreement existing with seller 40.

If a single transaction factoring agreement is involved as shown in step 377, seller 50 has the obligation to collect payment from buyer 50. If this is successful, buyer 50 pays seller 40 directly as shown in step 378a, and the transaction is complete as shown in step 380. If seller 40 cannot collect from buyer 50 within the time specified in the single transaction factoring agreement, factor 30 becomes responsible for payment to seller 40 upon the seller's request as shown in step 378b. At this point, factor 30 pays seller 40 as shown in step 379. But from this payment, the appropriate commission to factor 30 as specified in the single transaction factoring agreement may be deducted. The appropriate commission to auction manager 1 as previously agreed may also be deducted. At this point, the transaction is complete as shown in step 380.

Alternatively, if a no-loan or loan factoring agreement (synonymous with existing clients of factor 30 as discussed above) is involved as shown in step 381, seller 40 need not attempt to collect payment from buyer 50. This is because per the terms of the factoring agreement, buyer 50 directly pays factor 30 within a specified time as shown in step 382a. The specified time for payment from buyer 50 to factor 30 may be specified on the invoice accompanying delivery of the goods or services. If buyer 50 does not timely pay factor 30, the invoice becomes past due as shown in step 382b. This reflects a fraud-avoidance aspect of the current invention in that seller 40 is not burdened with having to expend time and money in trying to collect on the past due invoice 382b.

In either case where buyer 50 timely pays factor 30 as in step 382a or where the invoice becomes past due as in step 382b, factor 30 pays seller 40 as per the factoring agreement in place as shown in step 383. As mentioned above, the appropriate commission to factor 30 as specified in the factoring agreement may be deducted from this payment as may the appropriate commission to auction manager 1 as previously agreed. At this point, the transaction is complete as shown in step 384.

The foregoing represents how the use of a factor in an auction setting is a novel aspect of the current invention. That is, sellers 40 may participate in auction 5 with a reasonable level of confidence that they will get paid regardless of whether the buyer reneges on the deal as in steps 378b or 382b. This is in sharp contrast to the situation where before, sellers faced some amount of risk in selling goods and/or services via an auction because no factor was involved and there was thus no guarantee of getting paid. The use of a factor provides a large practical benefit. That is, because the use of a factor instills a high degree of confidence in the auction 5, more sellers will be attracted to participate in the auction. As a result, the auction becomes more robust with more sellers competing and more commerce occurring.

Still referring to FIG. 2, the scenario 376b where buyer 50 disputes the items delivered after auction 5 is now discussed. As shown, it is preferred that some type of dispute resolution mechanism be provided so that a settlement between seller 40 and buyer 50 may be reached as shown in step 385. For example, auction manager 1 may provide some type of arbitration or mediation mechanism that may be agreed to by both sellers 40 and buyers 50 upon applying to participate in auction 5. The dispute resolution included in the current invention again reflects fraud avoidance.

The current invention contemplates various scenarios to settle such disputes. An example is where buyer 50 returns some portion of the auctioned items to seller 40 as shown in step 386 and some proportion of the original payment amount is agreed upon. This may occur if a portion of the auctioned items are defective or do not otherwise live up to the description posted during the auction. In this scenario, buyer 50 preferably makes a partial payment reflecting the remainder due, i.e., payment for the items not returned. Where a single transaction factoring agreement is involved as shown in step 387, seller 40 may collect the proportional payment from buyer 50 as shown in step 388a and the transaction is complete as shown in step 390.

If buyer 50 fails to pay seller 40 within a specified time as shown in step 388b, factor 30 then becomes responsible for the proportional payment to seller 40. Factor 30 may then pay seller 50 the proportional amount, but as discussed above, the appropriate factoring commission and commission to auction manager 1 may be deducted from this payment. At this point, the transaction is complete as shown in step 390. It should be noted that where settlement 385 was made necessary because seller 40 delivered improper items, the transaction may not do much, if anything, to improve the seller's track record from the viewpoint of factor 30. Accordingly, the transaction may not serve to qualify seller 40 for a full service factoring agreement, e.g., a no-loan or loan factoring agreement.

Another dispute resolution mechanism contemplated by the current invention involves the merchandise being discounted as shown in step 391. This may again be necessary because some or all of the auctioned items were not as good as or otherwise different than the description posted during the auction. In this scenario, buyer 50 preferably makes a partial payment reflecting the discount. Where a no-loan or loan factoring agreement (synonymous with existing clients of factor 30 as discussed above) is involved as shown in step 391, seller 40 need not attempt to collect the partial payment from buyer 50. This is because per the terms of the factoring agreement, buyer 50 pays factor 30 within a specified time directly as shown in step 393a. The specified time for payment from buyer 50 to factor 30 may be specified on the invoice accompanying delivery of the goods or services.

If buyer 50 does not timely pay factor 30, the invoice becomes past due as shown in step 393b and factor 30 then becomes responsible for the proportional payment to seller 40. Factor 30 may then pay seller 40 the proportional amount, but as discussed above, the appropriate factoring commission and commission to auction manager 1 may be deducted from this payment. At this point, the transaction is complete as shown in step 395.

As noted above, where the settlement 385 involving a discount was made necessary because seller 40 delivered improper items, the transaction may not do much, if anything, to improve the seller's track record from the viewpoint of factor 30. Accordingly, the transaction may not serve to qualify seller 40 for a factoring agreement providing more service, e.g., in the case of a no-loan factoring agreement, this transaction would not favor the seller's graduation to a loan factoring agreement.

These scenarios again represent the benefit of the novel use of a factor in the auction setting. That is, even where there is a dispute, the seller 40 is guaranteed at least a partial payment. And the fact that only a partial payment is made may be entirely proper since some of the auctioned items may be of substandard quality or inappropriate for other reasons. Accordingly, the seller's degree of confidence of getting paid because of the factor's involvement may serve to attract more sellers to the auction which in turn provides for more competition and a more robust auction.

These scenarios also again represent the fraud avoidance aspect of the current invention in relation to the buyer. That is, fraud against the buyer is avoided because if the auctioned items were defective or otherwise not fitting the description posted during the auction, it is reasonable for buyer 50 to dispute the auctioned items, return certain items and/or pay a partial or discounted price.

Still referring to FIG. 2, the scenario where the buyer declines the auctioned items as shown in step 376c is now discussed. Here, instead of raising a dispute, buyer 50 may simply decline the auctioned items if they are not as posted during the auction. In this scenario, buyer 50 may return the auctioned items within a certain amount of time, such as thirty days, as shown in step 396. Here, the transaction is not consummated as shown in step 397. This scenario again reflects the fraud avoidance aspect of the current invention in that buyer 50 should not be stuck with items that do not comport with that posted during the auction. Accordingly, fraud on the buyer 50 is avoided.

It is preferred that auction manager 1 and/or factor 30 keep track of the transactions that end up being consummated or not consummated so that the integrity of auction 5 is maintained. For example, if a certain seller 40 repeatedly ships items that are different than those posted during the auction (as in scenario 376c), that particular seller 40 might eventually be expelled from auction 5 or lose its factoring agreement with factor 30.

As another example, if a certain buyer 50 repeatedly disputes items it has purchased (as in scenario 376b), auction manager 1 may investigate whether the disputes are made in good faith. If it turns out that buyer 50 is improperly instigating disputes, this particular buyer 50 might also be expelled from auction 5 or have its credit limit reduced. Instead of being expelled outright, buyers 40 or sellers 50 might alternatively be placed on probation or temporarily suspended from auction 5.

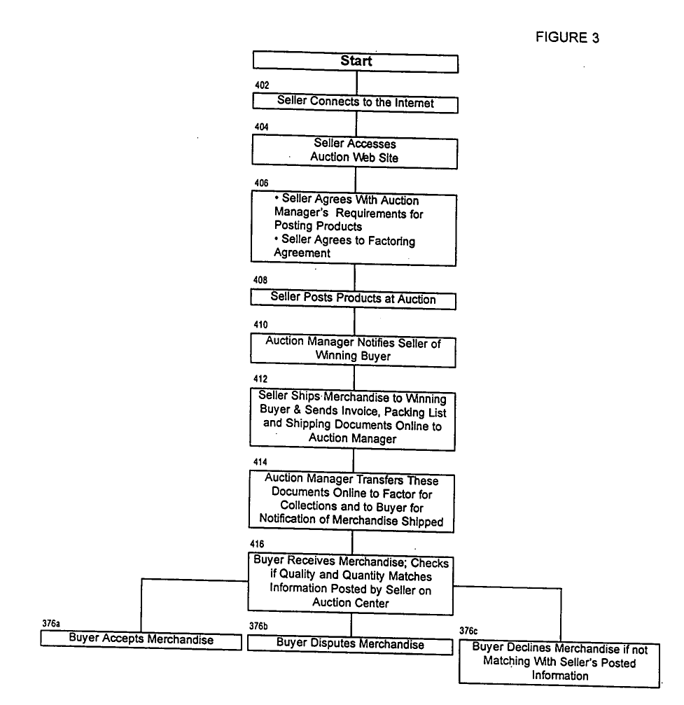

Referring now to FIG. 3, the method of the current invention is shown from the seller's viewpoint starting at step 400. While portions of the following discussion may be similar to the seller's side process 302 discussed in connection with FIG. 2, more detail is provided on points as they concern seller 40.

As shown, a prospective seller may visit the Internet as shown in step 402 and access auction manager's web site 10 as shown in step 404. This is not to say that a prospective seller cannot learn of the auction 5 through alternate, non-Internet means such as other forms of advertising, e.g., direct mail or trade publications relevant to the goods and/or services being auctioned.

Upon visiting the web site 10 of auction manager 1, a prospective seller may preferably view the online agreements to be entered into with auction manager 1 and factor 30. For example, web site 10 may include icons that the prospective seller may click on to call up the auction agreement with auction manager 1 and the factoring agreement with factor 30. The agreements may contain whatever terms are deemed necessary by auction manager 1 and factor 30 such as a minimum posting requirement, delivery times for auctioned items, payment terms and the rate of commission and/or fee to be paid by seller 50.

With respect to factoring agreements, web site 10 may provide samples of the single transaction agreement 306, the no-loan factoring agreement 322 and the loan factoring agreement 330 (FIG. 2) online so that the prospective seller may readily consider what types of factoring options are available. And for prospective sellers that are already clients of factor 30, web site 10 may also include information on how that existing relationship may be used in connection with auction 5.

As shown in step 406, the prospective seller may then submit the appropriate information to apply to become a seller 50 authorized to participate at auction 5, and to apply for the desired factoring agreement. As discussed above, it is preferred that auction manager 1 and factor 30 each have some amount of time in which to review the application in order to determine whether the prospective seller should be allowed to participate in auction 5.

Once seller 50 has become authorized to participate, it may post goods and/or services for auction 5 as shown in step 408. It is preferred that seller 50 post whatever information that is necessary to describe the goods or services being offered. This preferably includes electronics graphical files so that buyers 50 may actually see what they are bidding on.

Auction 5 may then occur and a winning buyer 50 is designated. Depending on the type of factoring agreement in place, auction manager 1 may provide seller 50 with the information on the designated winning buyer 50 as shown in step 410. But as discussed in connection with FIG. 2, in the case of a single transaction factoring agreement 306, this information may not be released to seller 40 until appropriate commissions or fees have been paid to auction manager 1 and factor 30.

At this point, seller 40 ships the auctioned items to the designated winning buyer 50, and the shipping information may also be sent to auction manager 1 and factor 30 as shown in step 412. As mentioned above, this shipping information may include an invoice, packing list and shipping documents. Preferably, this information is sent to auction manager 1 online, but hard copy documents may also be sent. Upon receiving this information, auction manager 1 will be able to determine the commission and/or fee to be forthcoming from seller 40, and may also be able to maintain information on what transactions are occurring on its auction 5.

Depending on the type of factoring agreement 30 in place, seller 40 may then collect payment (in the case of the single transaction agreement 306) or seller may receive payment from factor 30 (in the case of the more full-service type of no-loan or loan factoring agreements 322,330). Where factor 30 will collect payment from buyer 50, auction manager 1 may forward the shipping information to factor 30 as shown in step 414. This preferably occurs online though hard copy documents may also be used. Auction manager 1 may also forward the shipping information from seller 40 to buyer 50 so that buyer 50 knows it submitted the highest bid and will be receiving the auctioned items from seller 40.

At this point, the method may proceed as discussed in connection with the factor's viewpoint in FIG. 2. That is, buyer 50 may accept the auctioned items as shown in step 376a, dispute the auctioned items as shown in step 376b or may decline the auctioned items as shown in step 376c. But in all three scenarios, the risk of fraud against seller 40 is avoided.

For example, where the buyer accepts the auctioned items but does not pay for them as indicated in the scenario represented by steps 376a-380 or 376a-384, seller 40 will receive payment from factor 30 (less any commissions and/or fees due to auction manager 1 and factor 30). And while seller 40 may first have to expend effort in attempting to collect payment in the case of single transaction factoring agreement 306, if buyer 50 does not pay, seller 40 still receives payment from factor 30.

As another example, seller 40 receives at least a partial payment or a discounted, settled payment (less any commissions and/or fees due to auction manager 1 and factor 30) where buyer 50 disputes the auctioned items as indicated in the scenario comprising steps 376b-390 or 375-3965. However, this still reflects fraud-avoidance protection for seller 40 in that though the auctioned items may have been disputed, seller 40 may still participate in any dispute resolution process offered by auction manager 1. Furthermore, that portion of the disputed auctioned items that buyer 50 is not paying for, will be returned to seller 40. Also, it may be that good reason existed for the dispute, in which case it is reasonable for seller 40 to receive payment only for those goods kept by buyer 50, or a discounted payment.

As another example, where the auctioned items are declined by the buyer as shown in the scenario comprising steps 376c-397, the auctioned items are returned to seller 40. And where the auctioned items are declined because they did not match those posted during the auction, it is only reasonable for seller 40 to accept their return.

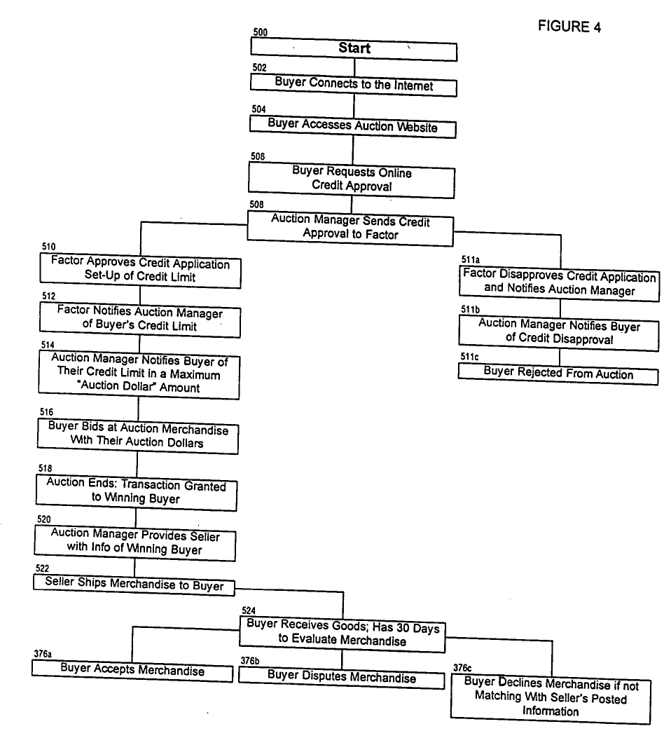

Referring now to FIG. 4, the method of the current invention is shown from the buyer's viewpoint starting at step 500. Again, some of this discussion may be similar to that discussed in connection with FIG. 2, but certain points are expanded upon from the buyer's perspective. A prospective buyer may visit the Internet as shown in step 502 and access the auction manager's web site 10 as shown in step 504. As with the prospective seller, a prospective buyer may learn of the auction 5 through alternate means such as other forms of advertising, e.g., direct mail, trade publications relevant to the goods and/or services being auctioned, etc.

Upon visiting the web site 10 of auction manager 1, a prospective buyer may request credit approval to participate in the auction 1 as shown in step 506. It is preferred that the credit approval request occur online whereby the prospective buyer fills in information into electronic forms appearing on a computer screen. The prospective buyer may thus submit a credit application online to auction manager 1. Alternatively, this may occur with hard copy documents. Upon receiving the prospective buyer's application, auction manager 1 may forward it on to factor 30 as shown in step 508. Alternatively, the credit application may be submitted directly to factor 30. This preferably occurs online though hard copy documents may be used.

As indicated in connection with FIG. 2, for prospective buyers that are existing clients of factor 30, a credit check may be unnecessary. But for buyers that are not clients of factor 30, a credit check fee may be charged and action manager 1 may also perform due diligence checks, e.g., where the buyer's shipping and billing addresses are different.

At this point, both auction manager 1 and factor 30 may have some amount of time to determine whether the prospective buyer should be authorized to participate in auction 5. To this end, factor 30 may perform any type of necessary credit check and other background investigation. Auction manager 1 may also assess the prospective buyer's application to determine whether its needs are in line with goods or services being auctioned at the auction 5.

Factor 30 may then approve the prospective buyer as shown in step 510 or may reject the credit application as shown in steps 511a, 511b and 511c. In the case of rejection, factor 30 may notify auction manager 1 of the rejection as shown in step 511a, and auction manager 1 may then notify the prospective buyer as shown in step 511b. At this point, the buyer is rejected as shown in step 511c. Despite rejection, the prospective buyer may be able to re-apply at some time in the future if its credit situation changes. To this end, it is preferred that auction manager 1 retain information on rejected buyers for future consideration should the buyer re-apply.

If factor 30 approves the buyer's application, a credit limit is set up as shown in step 510. At this point, factor 30 may notify auction manager 1 of the buyer's credit limit for use at the auction 5 as shown in step 512. Auction manager 1 may then notify buyer 50 of the approval as well as the buyer's credit limit of auction dollars as shown in step 514.

As discussed above, the buyer's credit limit is expressed in auction dollars which represents how much buyer 50 may bid on a given auction. However, if buyer 50 has spent some portion of its limit on items in an earlier auction that have not yet been paid for, the buyer's available auction dollars for a subsequent-auction may be lowered accordingly. If a buyer 50 attempts to bid more than its available credit, the bid may be denied by auction manager 1. In this manner, auctions may be run in an orderly manner in that buyers 50 cannot submit bids which they cannot likely back up.

Once buyer 50 has become authorized to bid at auctions, it may bid on goods or services posted at the auction 1 as shown in step 516. The auction may then end with a winning bidder being designated as shown in step 518. The winning buyer 50 may be notified by auction manager 1 that is has submitted the winning bid, and auction manager 1 may provide the winning buyer's information to seller 40, as shown in step 520, so that seller 40 may ship the auctioned items as in step 522. But as discussed above buyer 50 and seller 40 may not be notified until after the appropriate fees or commissions have been paid to auction manager 1 and factor 30.

Buyer 50 may then receive the auctioned items as shown in step 524, and may receive some amount of time to evaluate the items. In a preferred embodiment, this time is thirty days which provides buyer 50 with ample time to ensure that the items comport with those posted during the auction. This evaluation period helps avoid fraud perpetrated against buyer 50.

Upon the buyer's receipt of the auctioned items, the method of the current invention may proceed as discussed in connection with the factor's viewpoint of FIG. 2. That is, buyer 50 may accept the auctioned items as shown in step 376a, dispute the auctioned items as shown in step 376b or may decline the auctioned items as shown in step 376c. But in all three scenarios, the risk of fraud against buyer 50 is avoided.

For example, where buyer 50 accepts the auctioned items as indicated in the scenario comprising steps 376a-380 or 376a-384, buyer 50 simply pays seller 40 or factor 30 the appropriate amount and the transaction is complete. In this scenario, buyer 50 accepted the items and simply paid for them. Upon payment, the auction dollars used by buyer 50 for that particular auction are freed up for use in subsequent auctions.

Where buyer 50 accepts the auctioned items but does not pay for them timely as shown in step 378b, 382b, buyer 50 will have to deal with factor 30 in collection proceedings as in step 540. However, this is only reasonable since buyer 50 accepted the auctioned items. It bears reiterating that even where collection proceedings are necessary, seller 40 is still paid by factor 30, as shown by steps 379 and 383 thereby avoiding the risk of fraud on that seller.

Where buyer 50 disputes the auctioned items, it may participate in any dispute resolution procedure that auction manager 1 may provide as shown in the steps following step 376b. One possible settlement that avoids risk to the buyer may involve buyer 50 returning a portion of the auctioned items as shown in the scenario comprising steps 376b-390. Here, buyer 50 is only paying the items that are deemed acceptable and is returning the other items. Alternatively, a dispute may be settled whereby buyer 50 pays a discounted amount as shown in the scenario comprising steps 376b-395. Here, buyer 50 is paying a settled amount which would presumably reflect the real worth of the auctioned items. In either scenario, buyer 50 is protected from having to keep and/or pay full price for auctioned items that differ from or are lesser in value than those posted during the auction.

Where buyer 50 declines the auctioned items as shown in the scenario comprising steps 376c-397, the auctioned items are returned:to seller 40 and buyer 50 does not pay for them. Accordingly, buyer 50 is protected against having to keep any auctioned items that differ from what was posted during the auction.

Although certain presently preferred embodiments of the invention have been described herein, it will be apparent to those skilled in the art to which the invention pertains that variations and modifications of the described embodiments may be made without departing from the spirit and scope of the invention.

1. A method for providing an auction, comprising:
providing at least one seller that posts goods or services to be sold at the auction;
providing one or more buyers to bid on the goods or services;
providing an auction manager to conduct the auction wherein the one or more buyers bid on the posted goods or services;
designating a winning buyer; and
providing a guarantee by a financial institution to pay at least a portion of the payment due from the winning buyer to the seller.

2. The method of claim 1, wherein the financial institution is a factoring entity, a bank or a credit assurance company.

3. The method of claim 2 wherein the guarantee is a single transaction factoring agreement.

4. The method of claim 2 wherein the guarantee is a no-loan factoring agreement.

5. The method of claim 2 wherein the guarantee is a loan factoring agreement.

6. The method of claim 1, further comprising:
posting the goods or services online at a web site; and
conducting the auction online at the web site wherein the one or more buyers submit their bids online.

7. The method of claim 1, further comprising:
providing a plurality of sellers that post goods or services to be sold at the auction;
providing a plurality of buyers to bid on the goods or services;
conducting a plurality of auctions simultaneously;
designating a plurality of winning buyers; and
providing a guarantee by a financial institution to pay at least a portion of the payment due from the winning buyers to the sellers.

8. The method of claim 1 wherein the at least one seller applies online for the guarantee by the financial institution prior to posting goods or services for sale at the auction.

9. The method of claim 1 wherein at least one of the one or more buyers apply online for a credit check prior to bidding on goods or services for sale at the auction.

10. The method of claim 1 wherein a portion of the sales price of the goods or services sold at the auction is paid to the auction manager and/or financial institution.

11. The method of claim 1 wherein the financial institution receives commissions from the at least one seller in consideration for providing the guarantee, and wherein the auction manager receives a commission for each guarantee provided by the financial institution.

12. A method for providing an auction, comprising:
providing at least one seller that posts goods or services to be sold at the auction;
providing one or more buyers to bid on the goods or services;
providing an auction manager to conduct the auction wherein the one or more buyers bid on the posted goods or services;
designating a winning buyer; and
providing the winning buyer with a period of time in which to inspect the auctioned goods or services before payment is due.

13. The method of claim 12, further comprising:
posting the goods or services online at a web site; and
conducting the auction online at the web site wherein the one or more buyers submit their bids online.

14. The method of claim 12, further comprising:
providing a plurality of sellers that post goods or services to be sold at the auction;
providing a plurality of buyers to bid on the goods or services; and
conducting a plurality of auctions simultaneously;
designating a plurality of winning buyers; and
providing a guarantee by a financial institution to pay at least one of the sellers a portion of the payment due from the winning buyers to the at least one seller.

15. The method of claim 14 wherein the least one of the sellers applies online for the guarantee by the financial institution.

16. The method of claim 12 wherein at least one of the one or more buyers apply online for a credit check prior to bidding on goods or services for sale at the auction.

17. The method of claim 12 wherein a portion of the sales price of the goods or services sold at the auction is paid to the auction manager.

18. The method of claim 12 wherein the time period is 30 days.

19. A method for providing an auction, comprising:
providing at least one seller that posts goods or services to be sold at the auction;
providing one or more buyers to bid on the goods or services;
providing an auction manager to conduct the auction wherein the one or more buyers bid on the posted goods or services;
designating a winning buyer;
providing a guarantee by a financial institution to pay at least a portion of the payment due from the winning buyer to the seller; and
providing the winning buyer with a period of time in which to inspect the auctioned goods or services before payment is due.

20. The method of claim 19, wherein the financial institution is a factoring entity, a bank or a credit assurance company.

21. The method of claim 20 wherein the guarantee is a single transaction factoring agreement.

22. The method of claim 20 wherein the guarantee is a no-loan factoring agreement.

23. The method of claim 20 wherein the guarantee is a loan factoring agreement.

24. The method of claim 19, further comprising:
posting the goods or services online at a web site; and
conducting the auction online at the web site wherein the one or more buyers submit their bids online.

25. The method of claim 19, further comprising:
providing a plurality of sellers that post goods or services to be sold at the auction;
providing a plurality of buyers to bid on the goods or services;
conducting a plurality of auctions simultaneously;
designating a plurality of winning buyers; and
providing the guarantee by the financial institution to pay at least a portion of the payment due from the winning buyers to at least one of the sellers.

26. The method of claim 19 wherein the at least one seller applies online for the guarantee by the financial institution prior to posting goods or services for sale at the auction.

27. The method of claim 19 wherein at least one of the one or more buyers apply online for a credit check prior to bidding on goods or services for sale at the auction.

28. The method of claim 19 wherein a portion of the sales price of the goods or services sold at the auction is paid to the auction manager and/or financial institution.

29. The method of claim 19 wherein the financial institution receives commissions from the at least one seller in consideration for providing the guarantee, and wherein the auction manager receives a commission for each guarantee provided by the financial institution.

30. The method of claim 19 wherein the time period is 30 days.
